(19) United States
(12) Patent Application Publication
(10) Pub. No.: US 2020/0306731 A1
(43) Pub. Date: Oct. 1, 2020

(54) CATALYTIC ARTICLE COMPRISING A COPRECIPITATE OF VANADIA, TUNGSTA, AND TITANIA

(71) Applicant: BASF Corporation, Florham Park, NJ (US)

(72) Inventors: Gary A. Gramiccioni, Madison, AL (US); Pascaline Tran, Holmdel, NJ (US); Joseph A. Patchett, Basking Ridge, NJ (US); Thomas A. Gegan, Edison, NJ (US)

(21) Appl. No.: 16/309,249

(22) PCT Filed: Jun. 8, 2017
(86) PCT No.: PCT/IB2017/053403

§ 371 Date: Dec. 12, 2018

Related U.S. Application Data
(60) Provisional application No. 62/349,210, filed on Jun. 13, 2016.

(51) Int. Cl. B01J 23/30; B01J 35/00; B01J 35/10; B01J 37/03; B01J 37/00; B01J 37/02; B01D 53/94; F01N 3/20

(52) U.S. Cl. CPC B01J 23/30; B01D 2255/9202; B01J 35/1019; B01J 35/006; B01J 35/1071; B01J 37/031; B01J 37/0009; B01J 37/0236; B01J 37/0215; B01D 53/9418; F01N 3/2066; B01D 2255/9155; B01D 2255/20723; B01D 2255/20776; B01D 2255/20707; B01D 2255/9207; B01D 2255/9205; B01J 35/0013

(57) ABSTRACT

The present disclosure provides catalytic materials formed of co-precipitates of vanadium, tungsten, and titanium, catalytic articles formed using such co-precipitates, and methods of making such precipitates. The co-precipitates may be used in the form of calcined particles, and catalytic articles incorporating coatings formed of the co-precipitate can exhibit improved adhesion and performance.

### FIELD OF THE DISCLOSURE

The present disclosure relates to catalytic materials and catalytic articles prepared therefrom. In particular, the present disclosure relates to co-precipitates comprising vanadia, tungsta, and titania, said co-precipitates being useful in forming catalytic materials and catalytic articles with improved properties.

### BACKGROUND

Catalytic converters are well known for the removal and/or conversion of harmful components typically found in exhaust gases from the combustion of hydrocarbon fuels. Nitrogen oxides (NOₓ) in particular are known pollutants that may be found in exhaust gases, such as from internal combustion engines (e.g., in automobiles and trucks), from combustion installations (e.g., power stations heated by natural gas, oil, or coal), and from nitric acid production plants.

Various treatment methods have been used for the treatment of NOₓ-containing gas mixtures to decrease atmospheric pollution. One type of treatment involves catalytic reduction of nitrogen oxides. There are two processes: (1) a nonselective reduction process wherein carbon monoxide, hydrogen, or a lower hydrocarbon is used as a reducing agent; and (2) a selective reduction process wherein ammonia or an ammonia precursor is used as a reducing agent. In the selective reduction process, a high degree of nitrogen oxide removal can be achieved with a small amount of reducing agent.

The selective reduction process is referred to as a SCR (Selective Catalytic Reduction) process. The SCR process uses catalytic reduction of nitrogen oxides with a reductant (e.g., ammonia) in the presence of atmospheric oxygen, resulting in the formation predominantly of nitrogen and steam:
4NO+4NH₃+O₂→4N₂+6H₂O (standard SCR reaction)
2NO₂+4NH₃→3N₂+6H₂O (slow SCR reaction)
NO+NO₂+NH₃→2N₂+3H₂O (fast SCR reaction)

Catalysts employed in the SCR process ideally should be able to retain good catalytic activity over a wide range of temperature conditions of use, for example, 200° C. to 600° C. or higher, under hydrothermal conditions. SCR catalysts are commonly employed in hydrothermal conditions, such as during the regeneration of a soot filter, a component of the exhaust gas treatment system used for the removal of particles. Many SCR catalysts include vanadia and/or tungsta as active agents supported on titanium dioxide.

While catalytic converters can have a variety of constructions, one form of construction is a catalytically coated rigid skeletal monolithic substrate, or honeycomb-type element which has a multiplicity of longitudinal channels or cells to provide a catalytically coated body having a high surface area. The rigid, monolithic substrate can be fabricated from ceramics and other materials. Such materials and their construction are described, for example, in U.S. Pat. Nos. 3,331,787 and 3,565,830 each of which is incorporated herein by reference.

A monolithic honeycomb substrate will typically have an inlet end and an outlet end, with multiple mutually adjacent cells extending along the length of the substrate body from the inlet end to the outlet end. These honeycomb substrates typically have from about 100 to 600 cells-per-square-inch (cpsi); however, cell density can be in the range of about 10 cpsi to about 1200 cpsi. The cells can have round, square, triangular, or hexagonal cell shapes.

The open frontal area of a monolithic honeycomb substrate may comprise about 50% to about 85% of the surface area, and the cell wall thickness may be about 0.5 mils to about 10 mils, where 1 mil is 0.001 inches. The cells also may be separated from one another by walls with a thickness in the range of about 0.5 mils to about 60 mils (0.012 mm to 1.5 mm). The open frontal area may be as much as 91% for a 600 cpsi substrate with 2 mil cell wall thickness.

The cell walls of the substrate may be porous or non-porous, smooth, or rough. For porous walls, an average wall pore diameter may be from about 0.1 microns to about 100 microns, and wall porosity can be in the range of 10% to about 85%.

Such monolithic catalytic substrates may have one, two, or more catalytic coatings deposited on the cell walls of the substrate. Such coatings preferably maintain high porosity to allow passage of exhaust gases therethrough and maintain good and stable adhesion to prolong the life of the catalyst material. It would be useful to provide further catalyst compositions and catalytic articles formed therewith that exhibit desirable porosity and adhesion.

### SUMMARY OF THE DISCLOSURE

The present disclosure provides catalytic materials and catalytic articles useful in a variety of reactions including, but not limited to, selective catalytic reduction of NOx. Catalytic articles can include a catalytic material that comprises vanadia, tungsta, and titania (“VTT”), and optionally further metal species, and the catalytic articles can exhibit improved properties arising at least in part from the catalytic material including calcined particles of a co-precipitate of vanadia, tungsta, and titania.

In one or more embodiments, the present disclosure can relate to a co-precipitate comprising at least vanadia, tungsta, and titania. The co-precipitate can be in the form of a filter cake or calcined particles. The calcined particles particularly can provide catalytic articles with improved properties at least because of improved adhesion with the particles are applied as a washcoat.

In some embodiments, the present disclosure can relate to a catalytic article comprising a substrate that includes a catalytic material comprising calcined particles of a co-precipitate of vanadia, tungsta, and titania. In one or more embodiments, the catalytic article can be further defined in relation to one or more of the following statements which can be combined in any number and order.

The calcined particles of the co-precipitate can be predominately crystalline.

The calcined particles of the co-precipitate can exhibit conchoidal fractures.

The calcined particles of the co-precipitate can comprise agglomerates of individual nanoparticles. As an example, the agglomerates can have a particle size distribution of d10<20 μm, d50<100 μm, d90<210 μm. As another example, and the individual nanoparticles can have an average size of about 5 nm to about 20 nm.

The calcined particles of the co-precipitate can comprise a coarse fraction having an average size of greater than 150 μm and a fine fraction having an average size of less than 150 μm.

The calcined particles of the co-precipitate can have a BET surface area of about 100 m²/g to about 180 m²/g.

The calcined particles of the co-precipitate can comprise about 0.1% to about 15% by weight vanadia, about 1% to about 20% by weight tungsta, and the balance titania, said weights based on the total weight of the calcined particles of the co-precipitate.

About 50% or greater by weight of the titania in the calcined particles of the co-precipitate can be in the anatase form.

The titania can have an average crystallite size of about 5 nm to about 15 nm.

In one or more embodiments, the catalytic article can be configured such that the article can comprise a substrate and comprise a coating on one or more surfaces of the substrate, the coating including the catalytic material comprising the calcined particles of the co-precipitate.

A coating of the catalytic material comprising the calcined particles of the co-precipitate can exhibit a washcoat adhesion average weight loss of less than 3%.

A coating of the catalytic material comprising the calcined particles of the co-precipitate can be substantially free of any binder.

A coating of the catalytic material comprising the calcined particles of the co-precipitate can have a porosity of about 5,000 Angstroms to about 10,000 Angstroms (or other size range as described herein).

In one or more embodiments, the substrate of the catalytic article can be formed directly from the catalytic material.

For a substrate formed directly from the catalytic material, the catalytic material can comprise calcined particles of the co-precipitate and further can comprise a content of non-calcined co-precipitate of vanadia, tungsta, and titania.

The catalytic material can be a homogeneous mixture of the calcined particles of the co-precipitate and the non-calcined co-precipitate.

In one or more embodiments, the present disclosure can relate to a method of forming a catalytically active substrate. In particular, such method can comprise: extruding a mixture of a catalytic material into a desired form; and drying the extruded mixture to provide the catalytically active substrate. Preferably, in such methods, the mixture of a catalytic material can comprise: calcined particles of a co-precipitate of vanadia, tungsta, and titania; and a content of non-calcined co-precipitate of vanadia, tungsta, and titania.

In one or more embodiments, the present disclosure further can comprise a method of improving adhesion of a catalytic coating of vanadia and titania on a substrate. In particular, the method can comprise providing the coating as a material comprising calcined particles of a co-precipitate of vanadia, tungsta, and titania.

The invention includes, without limitation, the following embodiments.

Embodiment 1: A catalytic article comprising a substrate that includes a catalytic material comprising calcined particles of a co-precipitate of vanadia, tungsta, and titania.

Embodiment 2: The catalytic article of any previous or subsequent embodiment, wherein the calcined particles of the co-precipitate are predominately crystalline

Embodiment 3: The catalytic article of any previous or subsequent embodiment, wherein the calcined particles of the co-precipitate exhibit conchoidal fractures.

Embodiment 4: The catalytic article of any previous or subsequent embodiment, wherein the calcined particles of the co-precipitate comprise agglomerates of individual nanoparticles, the agglomerates having a particle size distribution of d10<20 μm, d50<100 μm, d90<210 μm, and the individual nanoparticles having an average size of about 5 nm to about 20 nm.

Embodiment 5: The catalytic article of any previous or subsequent embodiment, wherein the calcined particles of the co-precipitate comprise a coarse fraction having an average size of greater than 150 μm and a fine fraction having an average size of less than 150 μm.

Embodiment 6: The catalytic article of any previous or subsequent embodiment, wherein the calcined particles of the co-precipitate have a BET surface area of about 100 m²/g to about 180 m²/g.

Embodiment 7: The catalytic article of any previous or subsequent embodiment, wherein the calcined particles of the co-precipitate comprise about 0.1% to about 15% by weight vanadia, about 1% to about 20% by weight tungsta, and the balance titania, said weights based on the total weight of the calcined particles of the co-precipitate.

Embodiment 8: The catalytic article of any previous or subsequent embodiment, wherein about 50% or greater by weight of the titania in the calcined particles of the co-precipitate is in the anatase form.

Embodiment 9: The catalytic article of any previous or subsequent embodiment, wherein the titania has an average crystallite size of about 5 nm to about 15 nm.

Embodiment 10: The catalytic article of any previous or subsequent embodiment, wherein the article comprises the substrate and a coating on one or more surfaces of the substrate, the coating including the catalytic material comprising the calcined particles of the co-precipitate.

Embodiment 11: The catalytic article of any previous or subsequent embodiment, wherein the coating exhibits a washcoat adhesion average weight loss of less than 3%.

Embodiment 12: The catalytic article of any previous or subsequent embodiment, wherein the coating is substantially free of any binder.

Embodiment 13: The catalytic article of any previous or subsequent embodiment, wherein the coating has a porosity of about 5,000 Angstroms to about 10,000 Angstroms.

Embodiment 14: The catalytic article of any previous or subsequent embodiment, wherein the substrate is formed of the catalytic material.

Embodiment 15: The catalytic article of any previous or subsequent embodiment, wherein the catalytic material further comprises a content of non-calcined co-precipitate of vanadia, tungsta, and titania.

Embodiment 16: The catalytic article of any previous or subsequent embodiment, wherein the catalytic material is a homogeneous mixture of the calcined particles of the co-precipitate and the non-calcined co-precipitate.

Embodiment 17: A method of forming a catalytically active substrate, the method comprising: extruding a mixture of a catalytic material into a desired form; and drying the extruded mixture to provide the catalytically active substrate; wherein the mixture of a catalytic material comprises: calcined particles of a co-precipitate of vanadia, tungsta, and titania; and a content of non-calcined co-precipitate of vanadia, tungsta, and titania.

Embodiment 18: A method of improving adhesion of a catalytic coating of vanadia and titania on a substrate, the method comprising providing the coating as a material comprising calcined particles of a co-precipitate of vanadia, tungsta, and titania.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as combinable unless the context clearly dictates otherwise.

### BRIEF DESCRIPTION OF THE FIGURES

FIG. 1 is an X-Ray Diffraction (XRD) plot showing the Two-Theta (degree) peaks for a. calcined co-precipitate of vanadia, tungsta, and titania according to an exemplary embodiment of the present disclosure;

FIG. 2A is a Transmission Electron Microscope (TEM) image at 20K× magnification of agglomerates of individual nanoparticles of a calcined co-precipitate of vanadia, tungsta, and titania according to an exemplary embodiment of the present disclosure;

FIG. 2B is a Transmission Electron Microscope (TEM) image at 50K× magnification of agglomerates of individual nanoparticles of a calcined co-precipitate of vanadia. tungsta, and titania. according to an exemplary embodiment of the present disclosure;

FIG, 2C is a Transmission Electron Microscope (TEM image at 100K× magnification of agglomerates of individual nanoparticles of a calcined co--precipitate of vanadia, tungsta, and titania according to an exemplary embodiment of the present disclosure;

FIG. 2D is a Transmission Electron Microscope (TEM) image at 200K× magnification of agglomerates of individual nanoparticles of a calcined co-precipitate of vanadia, tungsta, and titania according to an exemplary embodiment of the present disclosure;

FIG. 3 illustrates an exemplary substrate in the form of a honeycomb monolith coated with a catalyst composition according to an exemplary embodiment of the present disclosure;

FIG. 4 shows a schematic depiction of an embodiment of an emission treatment system in which a catalyst material and/or catalyst article of the present disclosure can be utilized;

FIG. 5a is a scanning electron microscope (SEM) image of a comparative catalytic article with a washcoat of a catalytic material, the image showing a plurality of channels at 25× magnification;

FIG. 5b is an SEM image of the article of FIG. 5a showing the washcoat at four converging channel corners at 100× magnification;

FIG. 5c is an SEM image of the article of FIG. 5a showing the washcoat at a corner of a channel at 500× magnification;

FIG. 5d is an SEM image of the article of FIG. 5a showing the washcoat at a surface of a channel wall at 2000× magnification;

FIG. 5e is an SEM image of the article of FIG. 5a showing the washcoat at a surface of a channel wall at 5000× magnification;

FIG. 6a is a scanning electron microscope (SEM) image of a comparative catalytic article with a washcoat of a catalytic material, the image showing a plurality of channels at 25× magnification;

FIG. 6b is an SEM image of the article of FIG. 6a showing the washcoat at four converging channel corners at 100× magnification;

FIG. 6c is an SEM image of the article of FIG. 6a showing the washcoat at a corner of a channel at 500× magnification;

FIG. 6d is an SEM image of the article of FIG. 6a showing the washcoat at a surface of a channel wall at 2000× magnification;

FIG. 6e is an SEM image of the article of FIG. 6a showing the washcoat at a surface of a channel wall at 5000× magnification;

FIG. 7a is a scanning electron microscope (SEM) image of a catalytic article according to an embodiment of the present disclosure with a washcoat of a catalytic material comprising a co-precipitate of calcined particles of a co-precipitate of vanadia, tungsta, and titania, the image showing a plurality of channels at 25× magnification;

FIG. 7b is an SEM image of the article of FIG. 7a showing the washcoat at four converging channel corners at 100× magnification;

FIG. 7c is an SEM image of the article of FIG. 7a showing the washcoat at a corner of a channel at 500× magnification;

FIG. 7d is an SEM image of the article of FIG. 7a showing the washcoat at a surface of a channel wall at 2000× magnification;

FIG. 7e is an SEM image of the article of FIG. 7a showing the washcoat at a surface of a channel wall at 5000× magnification;

FIG. 8a is a scanning electron microscope (SEM) image of a catalytic article according to an embodiment of the present disclosure with a washcoat of a catalytic material comprising a co-precipitate of calcined particles of a co-precipitate of vanadia, tungsta, and titania, the image showing a plurality of channels at 25× magnification;

FIG. 8b is an SEM image of the article of FIG. 8a showing the washcoat at four converging channel corners at 100× magnification;

FIG. 8c is an SEM image of the article of FIG. 8a showing the washcoat at a corner of a channel at 500× magnification;

FIG. 8d is an SEM image of the article of FIG. 8a showing the washcoat at a surface of a channel wall at 2000× magnification;

FIG. 8e is an SEM image of the article of FIG. 8a showing the washcoat at a surface of a channel wall at 5000× magnification;

FIG. 9a is a scanning electron microscope (SEM) image of a comparative catalytic article with a washcoat of a catalytic material, the image being at 2000× magnification;

FIG. 9b is a scanning electron microscope (SEM) image of a catalytic article according to an embodiment of the present disclosure with a washcoat of a catalytic material comprising a co-precipitate of calcined particles of a co-precipitate of vanadia, tungsta, and titania, the image being at 2000× magnification; and

FIG. 9c is a scanning electron microscope (SEM) image of a catalytic article according to an embodiment of the present disclosure with a washcoat of a catalytic material comprising a co-precipitate of calcined particles of a co-precipitate of vanadia, tungsta, and titania, the image being at 2000× magnification.

### DETAILED DESCRIPTION OF THE DISCLOSURE

The invention now will be described more fully hereinafter through reference to various embodiments. These embodiments are provided so that this disclosure will be thorough and complete, and will fully convey the scope of the invention to those skilled in the art. Indeed, the invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The present disclosure relates to catalytic materials and catalytic articles formed from such catalytic articles. The catalytic materials include a plurality of metal oxides including, at a minimum, oxides of vanadium (i.e., vanadia), oxides of tungsten (i.e., tungsta), and oxides of titanium (i.e., titania). The catalytic materials are prepared via co-precipitation methods that result in filter cakes and calcined particles that can be used in forming catalytic articles providing improved properties.

To form the co-precipitate, precursor compounds for the desired metal species are dissolved to form an aqueous solution. Dissolution can be carried out with heating and/or with stirring. Heating may be from above room temperature up to a temperature of about 80° C., about 70° C., or about 60° C. In some embodiments, heating can be in the range of about 40° C. to about 80° C., about 40° C. to about 60° C., or about 45° C. to about 55° C.

Co-precipitation can be carried out using precursor compounds for a variety of metals in addition to V, W, and Ti. Further useful metals include Si, Al, Cr, Ni, Mn, Nb, Mo, Fe, Zr, Bi, Sb, and Ga. In some embodiments, rare earth elements may be used—i.e., Sc, Y, La, Ce, Pr, Nd, Pm, Sm, Eu, Gd, Tb, Dy, Ho, Er, Tm, Yb, and Lu.

Non-limiting examples of metal precursor compounds that can be used in forming a co-precipitate of vanadia, tungsta, and titania include ammonium metavanadate, ammonium metatungstate, and titanium oxysulfate, respectively. Once the metal compounds are in solution, precipitation can be carried out with addition of a precipitating agent. On one or more embodiments, the precipitating agent can be a pH-adjusting agent, preferably an alkalinizing agent. In some embodiments, the initial metal compound solution can be substantially acidic, such as having a pH that is about 4 or less, about 3 or less, or about 2 or less. The precipitating agent, for example, can be configured to raise solution pH to about 5 or greater, about 6 or greater, about 7 or greater, about 8 or greater, or about 9 or greater. The precipitating agent preferably can be configured to provide a solution pH of about 5 to about 10. Non-limiting examples of precipitating agents that may be used include ammonia species and hydroxides. In some embodiments, ammonium hydroxide may be used. Addition of the precipitating agent is effective to co-precipitate the metal species from the solution.

The co-precipitate can be filtered and washed to remove soluble by-products. Beneficially, the co-precipitate is sufficiently stable so that washing causes little to no loss of the metal precipitates. Washing can be carried out with, for example, DI water. Washing can be performed with various methods, such as using a Buchner funnel, filter press, or the like. In some embodiments, washing can comprise multiple steps wherein the filtrate is re-suspended, subjected to high-shear mixing (e.g., approximately 2000 rpm), and filtered.

The resulting filter cake that is recovered after washing and filtering comprises agglomerates of the co-precipitate. This filter cake can be used in this form or may be subjected to drying. The co-precipitate in the form of the filter cake can be used, in some embodiments, as a catalytic material to prepare catalytic articles.

The filter cake can be dried to provide the co-precipitate in the form of a granular solid. For example, in some embodiments, the co-precipitate can be dried in a calcining tray at a temperature of about 80° C. to about 200° C., about 90° C. to about 190° C., or about 100° C. to about 170° C. for a time of about 1 hour to about 48 hours, about 2 hours to about 36 hours, about 3 hours to about 24 hours, or about 4 hours to about 18 hours. The dried filter cake can be ground into a powder form.

In one or more embodiments, the dried filter cake can be calcined. Although the non-calcined filter cake can be useful as a catalytic material, calcining can impart specifically useful properties to the co-precipitate in relation to the form of the resulting material. The dried filter cake can be calcined at a temperature of about 300° C. to about 600° C., about 350° C. to about 550° C., or about 400° C. to about 500° C. for a time of about 10 minutes to about 12 hours, about 20 minutes to about 8 hours, about 30 minutes to about 6 hours, or about 1 hour to about 3 hours. As further described below, the resulting calcined particles of a co-precipitate of vanadia, tungsta, and titania are in the form of a hard, glass-like particles that are characterized by well-defined conchoidal fractures.

The co-precipitate can comprise about 0.1% to about 15% by weight vanadia (V₂O₅), about 1% to about 20% by weight tungsta (WO₃), and the balance titania (TiO₂). One or more further metal oxides can be present in a total amount of about 0.1% to about 20% by weight. In preferred embodiments, the vanadia concentration can be about 0.25% to about 12.5%, about 0.5% to about 10%, or about 1% to about 5% by weight, and the tungsta concentration can be about 2% to about 18%, about 5% to about 17%, or about 7% to about 15% by weight.

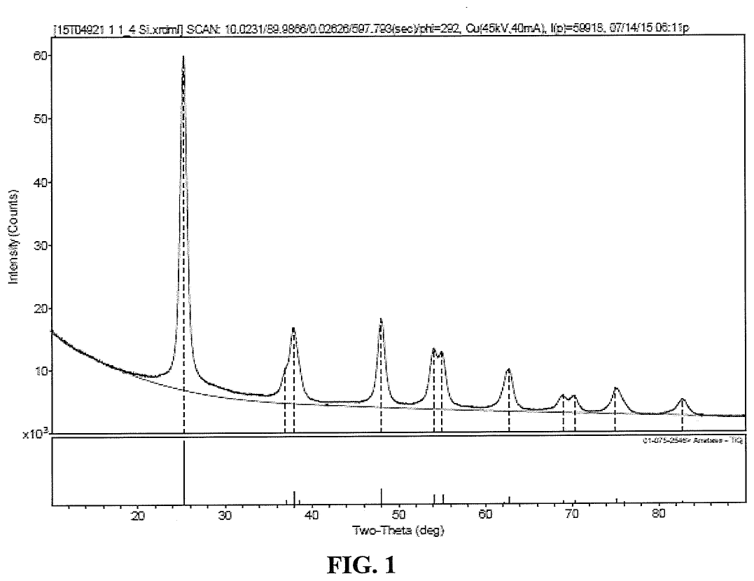

In one or more embodiments, the co-precipitate can be defined specifically in relation to certain characteristics of the calcined material. For example, the calcined co-precipitate can be substantially crystalline and exhibit little to no amorphous phase material. More specifically, the crystalline co-precipitate can comprise TiO₂ in the anatase form, preferably wherein about 50% or greater, about 75% or greater, about 90% or greater, or about 95% or greater of the TiO₂ by weight in the calcined co-precipitate is in the anatase form. The presence of the crystalline, anatase form can be seen in the XRD analysis results shown in FIG. 1, wherein the strong two-theta peak at about 25 degrees is indicative of the anatase TiO₂ present in the tested VTT sample. The anatase form TiO₂ can have a crystallite size of about 5 nm to about 15 nm, about 6 nm to about 14 nm, or about 8 nm to about 10 nm.

The crystalline structure of the calcined co-precipitate can provide for a very definitive physical nature that is believed to lead to unexpectedly good adhesion and porosity when used as a catalytic coating. In particular, the calcined co-precipitate can be substantially glass-like in nature. Fragments of the calcined co-precipitate exhibit conchoidal fractures, and these specifically shaped fractures can lead to a preferred packing arrangement that improves adhesion and/or porosity of coatings formed with the material.

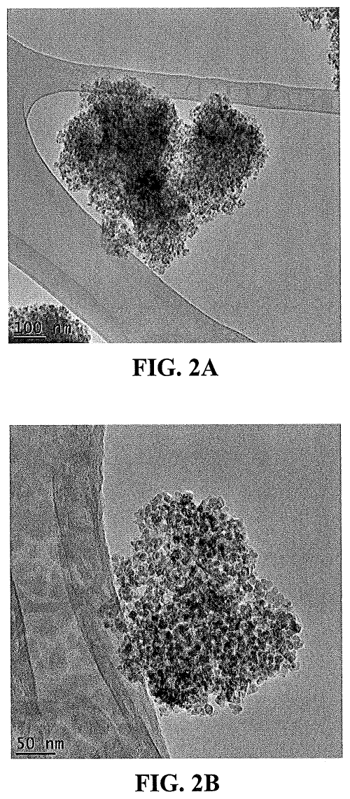

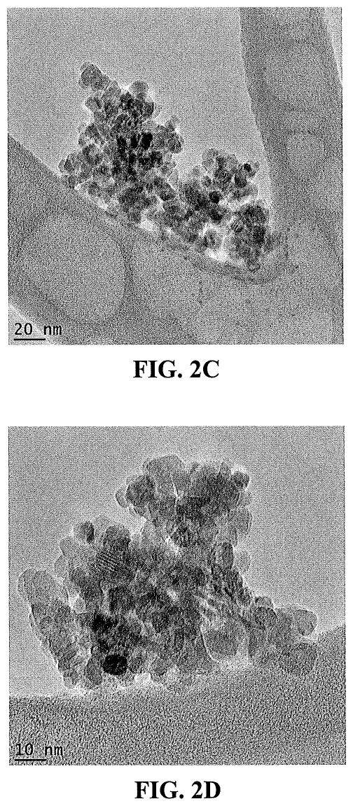

The calcined co-precipitate can specifically be provided in the form of particles that are agglomerates of individual nanoparticles. The agglomerates can have an average (D50) particle size of about 70 μm to about 150 μm, about 75 μm to about 125 μm, or about 80 μm, to about 110 μm. More particularly, the agglomerates can have a particle size distribution wherein d10<20 μm, d50<100 μm, and d90<210 μm. In some embodiments, the agglomerates can comprise a coarse fraction and a fine fraction, which coarse and fine fractions can be present in a ratio of about 2:1 to about 1:2, about 1.5:1 to about 1:1.5, or about 1:1. The coarse fraction can have an average size of greater than 150 μm (e.g., about 160 μm to about 400 μm, about 175 μm to about 350 μm, or about 200 μm to about 300 μm), and the fine fraction can have an average size of less than 150 μm (e.g., about 140 μm to about 1 μm, about 120 μm to about 10 μm, or about 110 μm to about 25 μm). As can be seen in FIG. 2A through FIG. 2D, the agglomerates are formed of many nanoparticles of the co-precipitate. In particular, the individual nanoparticles can have an average size of about 2 nm to about 50 nm, about 5 nm to about 20 nm, or about 7 nm to about 15 nm.

Catalytic materials comprising the co-precipitate of at least vanadia, tungsta, and titania can be used in forming a variety of catalytic articles. For example, in one or more embodiments, a catalytic article according to the present disclosure can comprise a substrate and a coating on one or more surfaces of the substrate. In such embodiments, the catalytic material can be present at least in the coating. In particular, the coating on the substrate can comprise calcined particles (i.e., agglomerates) of the co-precipitate. In some embodiments, the calcined particles of the co-precipitate can be used in a washcoat. As used herein, the term “washcoat” has its usual meaning in the art of a thin, adherent coating of a catalytic or other material applied to a carrier substrate material, such as a honeycomb-type carrier member, which is sufficiently porous to permit the passage of the gas stream being treated. As is understood in the art, a washcoat is obtained from a dispersion of particles in a slurry, which is applied to a substrate, dried and calcined to provide the porous washcoat.

A coating composition including particles of a co-precipitate as described herein can include substantially only the co-precipitate and a suspending agent, particularly, water. In some embodiments, one or more binder materials may be used. Added binders, when present, can be selected from any binder known to those in the art. In one or more embodiments, the additional binder can be titania, alumina, zirconia, or silica binder. For example, without limitation, the binder can be selected from titanium oxychloride (TiOCl₂), titanium oxysulfate (TiOSO₄), aluminum trihydrate (Al(OH)₃), boehmite (AlO(OH)), aluminum nitrate Al(NO₃)₃, SiO₂ sols (e.g. commercially available Nalco® 1034A), and zirconia compounds. In some embodiments, however, the coating composition can be expressly free of any binder.

In one or more embodiments, a catalyst composition including the co-precipitate can be applied to a substrate as a washcoat. As used herein, the term “substrate” refers to the monolithic material onto which the catalyst is placed, typically in the form of a washcoat. A washcoat is formed by preparing a slurry containing a certain solids content (e.g., 30-90% by weight) of catalyst in a liquid vehicle, which is then coated onto a substrate and dried to provide a washcoat layer.

In one or more embodiments, the substrate is selected from one or more of a flow-through honeycomb monolith, a wall-flow filter, a foam, or a mesh. The catalyst material can be applied to the substrate as a washcoat in particular, or in any other suitable form and/or coating process.

According to one or more embodiments, the substrate for the catalyst composition may be constructed of any material typically used for preparing automotive catalysts and will typically comprise a metal or ceramic honeycomb structure. The substrate typically provides a plurality of wall surfaces upon which the catalyst composition is applied and adhered, thereby acting as a carrier for the catalyst composition. Exemplary metallic substrates include heat resistant metals and metal alloys, such as titanium and stainless steel as well as other alloys in which iron is a substantial or major component. Such alloys may contain one or more of nickel, chromium, and/or aluminum, and the total amount of these metals may advantageously comprise at least 15 wt. % of the alloy, e.g., 10-25 wt. % of chromium, 3-8 wt. % of aluminum, and up to 20 wt. % of nickel. The alloys may also contain small or trace amounts of one or more other metals, such as manganese, copper, vanadium, titanium and the like. The surface or the metal carriers may be oxidized at high temperatures, e.g., 1000° C. and higher, to form an oxide layer on the surface of the substrate, improving the corrosion resistance of the alloy and facilitating adhesion of the washcoat layer to the metal surface. Ceramic materials used to construct the substrate may include any suitable refractory material, e.g., cordierite, mullite, cordierite-a alumina, silicon nitride, zircon mullite, spodumene, alumina-silica magnesia, zircon silicate, sillimanite, magnesium silicates, zircon, petalite, a alumina, aluminosilicates and the like.

Any suitable substrate may be employed, such as a monolithic flow-through substrate having a plurality of fine, parallel gas flow passages extending from an inlet to an outlet face of the substrate such that passages are open to fluid flow. The passages, which are essentially straight paths from the inlet to the outlet, are defined by walls on which the catalytic material is coated as a washcoat so that the gases flowing through the passages contact the catalytic material. The flow passages of the monolithic substrate are thin-walled channels which can be of any suitable cross-sectional shape, such as trapezoidal, rectangular, square, sinusoidal, hexagonal, oval, circular, and the like. Such structures may contain from about 60 to about 1200 or more gas inlet openings (i.e., “cells”) per square inch of cross section (cpsi), more usually from about 300 to 600 cpsi. The wall thickness of flow-through substrates can vary, with a typical range being between 0.002 and 0.1 inches. A representative commercially-available flow-through substrate is a cordierite substrate having 400 cpsi and a wall thickness of 6 mil, or 600 cpsi and a wall thickness of 4 mil. However, it will be understood that the invention is not limited to a particular substrate type, material, or geometry.

In alternative embodiments, the substrate may be a wall-flow substrate, wherein each passage is blocked at one end of the substrate body with a non-porous plug, with alternate passages blocked at opposite end-faces. This requires that gas flow through the porous walls of the wall-flow substrate to reach the exit. Such monolithic substrates may contain up to about 700 or more cpsi, such as about 100 to 400 cpsi and more typically about 200 to about 300 cpsi. The cross-sectional shape of the cells can vary as described above. Wall-flow substrates typically have a wall thickness between 0.002 and 0.1 inches. A representative commercially available wall-flow substrate is constructed from a porous cordierite, an example of which has 200 cpsi and 10 mil wall thickness or 300 cpsi with 8 mil wall thickness, and wall porosity between 45-65%. Other ceramic materials such as aluminum-titanate, silicon carbide and silicon nitride are also used a wall-flow filter substrates. However, it will be understood that the invention is not limited to a particular substrate type, material, or geometry. Note that where the substrate is a wall-flow substrate, the catalyst composition can permeate into the pore structure of the porous walls (i.e., partially or fully occluding the pore openings) in addition to being disposed on the surface of the walls.

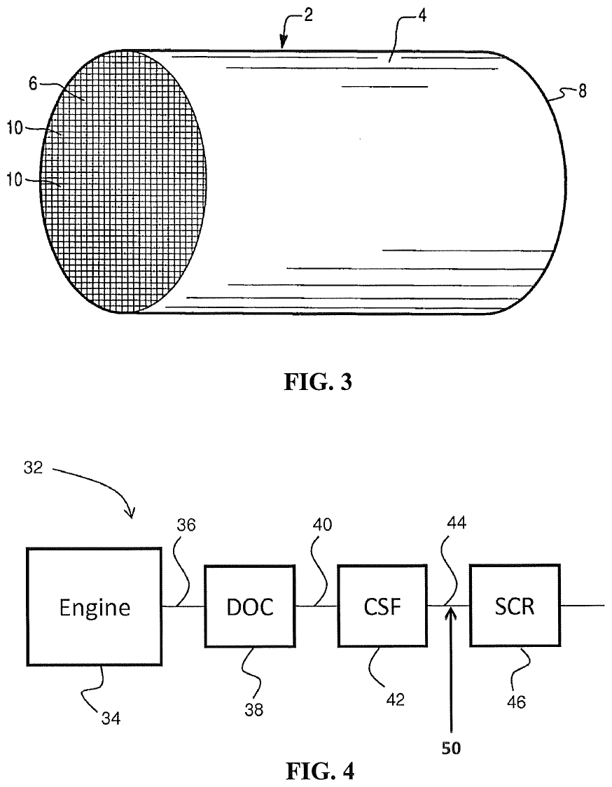

FIG. 3 illustrates an exemplary substrate 2 in the form of a honeycomb monolith coated with a catalyst composition as described herein. The exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. In the case of a flow-through monolith, the passages 10 are typically unobstructed so as to permit the flow of a fluid, e.g., a gas stream, longitudinally through carrier 2 via gas flow passages 10 thereof. Alternatively, the substrate 2 can be in the form of a wall-flow filter as discussed in detail above. In such an embodiment, each gas flow passage 10 is blocked at either the inlet or outlet end and the walls of the passages are porous to allow gas to travel from one gas flow passage into an adjacent gas flow passage, as would be understood in the art. If desired, the catalyst composition can be applied in multiple, distinct layers. The present invention can be practiced with one or more (e.g., 2, 3, or 4) washcoat layers.

To coat the substrates with the catalyst of one or more embodiments, the substrates are immersed vertically in a portion of the catalyst slurry such that the top of the substrate is located just above the surface of the slurry. In this manner slurry contacts the inlet face of each honeycomb wall, but is prevented from contacting the outlet face of each wall. The sample is left in the slurry for about 30 seconds. The substrate is removed from the slurry, and excess slurry is removed from the substrate first by allowing it to drain from the channels, then by blowing with compressed air (against the direction of slurry penetration), and then by pulling a vacuum from the direction of slurry penetration. By using this technique, in the case of a wall-flow substrate, the catalyst slurry permeates the walls of the substrate, yet the pores are not occluded to the extent that undue back pressure will build up in the finished substrate. As used herein, the term “permeate” when used to describe the dispersion of the catalyst slurry on the substrate, means that the catalyst composition is dispersed throughout the wall of the substrate and, thus, at least partially occlude the pores in the wall.

The coated substrates are dried typically at about 100° C. and ° d at a higher temperature (e.g., 300 to 450° C.). After calcining, the catalyst loading can be determined through calculation of the coated and uncoated weights of the substrate. As will be apparent to those of skill in the art, the catalyst loading can be modified by altering the solids content of the coating slurry. Alternatively, repeated immersions of the substrate in the coating slurry can be conducted, followed by removal of the excess slurry as described above.

Catalytic articles according to the present disclosure may include a single layer of a catalytic material formed of the presently described co-precipitate. The single layer can be utilized in the express absence of any further coating layers. Alternatively, catalytic articles can include multiple layers of a catalytic material formed of the presently described co-precipitate. Still further, catalytic articles can include one or more layers of a catalytic material formed of the presently described co-precipitate as an overcoat over one or more different coating layers or as an undercoat under one or more different coating layers. In light of the beneficial properties of coatings formed from the presently described co-precipitate, however, it can be particularly useful to form catalytic articles that include one or more of such layers without the coatings of any further catalytic materials.

In one or more embodiments, for example, coating layers formed of the presently described co-precipitate can exhibit desirable pore properties while also providing strong adhesion to the underlying substrate. In some embodiments, a coating layer formed of a co-precipitate as presently described can have a total pore volume (TPV) of about 0.1 cm³/g to about 0.5 cm³/g, about 0.12 cm³/g to about 0.4 cm³/g, or about 0.15 cm³/g to about 0.3 cm³/g. Further, in one or more embodiments, such coating layers can have a median pore volume radius of about 4,000 Angstroms to about 12,000 Angstroms, about 5,000 Angstroms to about 10,000 Angstroms, or about 6,000 Angstroms to about 9,000 Angstroms. By comparison, known vanadia/titania washcoats (e.g., prepared using commercially available TiO₂ made via the sulfate process with average particle sizes between 1 and 4 μm) typically have a median pore volume radius that is less than 3,000 Angstroms (predominately in the range of 2,000 Angstroms). As such, washcoats prepared using a co-precipitate as described herein can exhibit improved flow in light of the significantly larger pore sizes. Pore volume radius can be measured using known techniques, such as Hg Porosimetry. Pore characteristics may also be evaluated optically, such as through measurements of SEM images using appropriate devices, such as a VHX-5000 digital microscope. Coatings formed using a co-precipitate as described herein can exhibit a pore area (or pore size) that is greater than 1 μm², greater than 2 μm², or greater than 3 μm², such as in the range of about 1 μm²to about 8 μm², about 2 μm²to about 7 μm², or about 2.5 μm²to about 6 μm². These sizes can represent an increase relative to known vanadia/titania washcoats (see above) of at least 1.5×(i.e., a pore area that is at least 1.5 times the pore area of a known vanadia/titania washcoat), at least 2×, at least 3×, at least 4×, or at least 5×, such as in the range of about 1.5×to about 10×, about 2×to about 9×, or about 3×to about 8×.

Coatings formed of the presently described co-precipitate further can exhibit a BET surface area in excess of 60 square meters per gram (m²/g), often up to about 200 m²/g or higher. BET surface area has its usual meaning of referring to the Brunauer, Emmett, Teller method for determining surface area by N₂ adsorption. In some embodiments, a coating as presently disclosed can exhibit a BET surface area of about 60 m²/g to about 200 m²/g, about 70 m²/g to about 180 m²/g, or about 80 m²/g to about 150 m²/g.

Excellent adhesion properties exhibited by coatings formed of the present co-precipitate can be seen in relation to very low washcoat losses. Testing evaluating washcoat loss is described in the Examples below. According to such testing methods, coatings according to the present disclosure formed of the co-precipitate can exhibit an average washcoat loss of less than 2%, less than 1.75%, or less than 1.5% and can exhibit a weight loss of less of less than 0.7 wt %, less than 0.5 wt %, or less than 0.45 wt %, based on the total weight of the applied coating material. This can be a significant improvement over known washcoats including vanadia and titania. As such, the present disclosure thus provides methods for improving adhesion of a washcoat comprising vanadia and titania. In particular, the method can comprise applying a washcoat to a substrate, wherein the washcoat comprises calcined particles of a co-precipitate of vanadia, tungsta, and titania as otherwise described herein.

In one or more embodiments, a catalytic article according to the present disclosure can be configured such that the substrate is itself formed at least in part from the catalytic material comprising the presently described co-precipitate. Because of the excellent porosity and adhesive properties provided by the present catalytic co-precipitate, such material can be directly formed into a catalytic article comprising a plurality of porous walls. For example, the present catalytic co-precipitate can be used to form a flow-through honeycomb monolith, a wall-flow filter, or other like constructs typically utilize as substrates to which coating can be applied. According to the present disclosure, however, when such substrate is formed directly from the present co-precipitate, the use of added coating layers can be reduced or eliminated. Thus, in some embodiments, the substrate can consist essentially of the co-precipitate (i.e., in the absence of any further catalytic material but optionally including a binder), or the substrate can consist only of the co-precipitate.

In such embodiments, the catalytic article can be formed directly from the non-calcined co-precipitate filter cake, from the calcined particles of the co-precipitate, or from a mixture of the calcined particles of the co-precipitate and the non-calcined co-precipitate filter cake. For example, the catalytic material used to directly form such catalytic article can be a homogeneous mixture of the calcined particles of the co-precipitate and the non-calcined co-precipitate.

Further to the above, the present disclosure particularly can provide methods for forming catalytically active substrates. In one or more embodiments, such methods can comprise extruding a mixture of a catalytic material into a desired form and drying the extruded mixture to provide the catalytically active substrate. In particular, the mixture of a catalytic material can include calcined particles of a co-precipitate of vanadia, tungsta, and titania, and/or a non-calcined co-precipitate of vanadia, tungsta, and titania.

In one or more embodiments, the present disclosure can relate to an exhaust gas treatment system that can include one or more elements utilizing a catalyst material and/or a catalytic article according to the present disclosure. In some embodiments, the exhaust gas treatment system comprises an exhaust gas stream optionally containing a reductant like ammonia, urea, and/or hydrocarbon, and in specific embodiments, ammonia and/or urea, and a selective catalytic reduction catalyst comprising a washcoat including a small-pore molecular sieve having a pore structure and a maximum ring size of eight tetrahedral atoms and containing a promoter metal, and a zirconia containing layer on the small-pore molecular sieve containing the promoter metal according to one or more embodiments. The catalyst is effective for destroying at least a portion of the ammonia in the exhaust gas stream.

In one or more embodiments, the catalyst can be disposed on a substrate, for example a soot filter. The soot filter, catalyzed or non-catalyzed, may be upstream or downstream of the catalyst. In one or more embodiments, the system can further comprise a diesel oxidation catalyst. In various embodiments, the diesel oxidation catalyst is located upstream of the catalyst or the diesel oxidation catalyst and the catalyzed soot filter are upstream from the catalyst.

In specific embodiments, the exhaust is conveyed from the engine to a position downstream in the exhaust system. Where the exhaust contains NOₓ, a reductant, e.g. urea, is added and the exhaust stream which, with the added reductant, is conveyed to the catalyst.

For example, a catalyzed soot filter, a diesel oxidation catalyst, and a reductant are described in WO 2008/106519, which is herein incorporated by reference. In specific embodiments, the soot filter comprises a wall-flow filter substrate, where the channels are alternately blocked, allowing a gaseous stream entering the channels from one direction (inlet direction), to flow through the channel walls and exit from the channels from the other direction (outlet direction).

An ammonia oxidation catalyst (AMOx) may be provided downstream of the catalyst of one or more embodiments to remove any slipped ammonia from the system. In specific embodiments, the AMOx catalyst may comprise a platinum group metal such as platinum, palladium, rhodium, or combinations thereof.

Such AMOx catalysts are useful in exhaust gas treatment systems including an SCR catalyst. As discussed in commonly assigned U.S. Pat. No. 5,516,497, which is incorporated herein by reference, a gaseous stream containing oxygen, nitrogen oxides, and ammonia can be sequentially passed through first and second catalysts, the first catalyst favoring reduction of nitrogen oxides and the second catalyst favoring the oxidation or other decomposition of excess ammonia. As described in U.S. Pat. No. 5,516,497, the first catalysts can be a SCR catalyst comprising a zeolite and the second catalyst can be an AMOx catalyst comprising a zeolite.

AMOx and/or SCR catalyst composition(s) can be coated on the flow through or wall-flow filter. If a wall flow substrate is utilized, the resulting system will be able to remove particulate matter along with gaseous pollutants. The wall-flow filter substrate can be made from materials commonly known in the art, such as cordierite, aluminum titanate or silicon carbide. It will be understood that the loading of the catalytic composition on a wall flow substrate will depend on substrate properties such as porosity and wall thickness, and typically will be lower than loading on a flow through substrate.

One exemplary emissions treatment system is illustrated in FIG. 13, which depicts a schematic representation of an emission treatment system 32. As shown, an exhaust gas stream containing gaseous pollutants and particulate matter is conveyed via exhaust pipe 36 from an engine 34 to a diesel oxidation catalyst (DOC) 38 to a catalyzed soot filter (CSF) to a selective reductive catalyst (SRC), which is coated with the washcoat composition of the present invention. In the DOC 38, unburned gaseous and non-volatile hydrocarbons (i.e., the SOF) and carbon monoxide are largely combusted to form carbon dioxide and water. In addition, a proportion of the NO of the NOₓ component may be oxidized to NO₂ in the DOC.

The exhaust stream is next conveyed via exhaust pipe 40 to a catalyzed soot filter (CSF) 42, which traps particulate matter present within the exhaust gas stream. The CSF 42 is optionally catalyzed for passive or active soot regeneration. The CSF 42 can optionally include a SRC composition of the invention for the conversion of NOx present in the exhaust gas.

After removal of particulate matter, via CSF 42, the exhaust gas stream is conveyed via exhaust pipe 44 to a downstream selective catalytic reduction component 46 of the invention for the further treatment and/or conversion of NOₓ. The exhaust gas passes through the SCR component 46 at a flow rate which allows sufficient time for the catalyst composition to reduce the level of NOx in the exhaust gas at a given temperature. The SCR component 46 may optionally be included in the emission treatment system when CSF 42 already includes an SCR catalyst composition. An injector 50 for introducing a nitrogenous reducing agent into the exhaust stream is located upstream of the SRC 46. The introduced nitrogenous reducing agent into the gas exhaust stream promotes the reduction of the NOx to N₂ and water as the gas is exposed to the catalyst composition. If the CSF 42 also contains an SCR catalyst, the injector 50 can be moved to a position upstream of the CSF.

Embodiments of the present disclosure are further illustrated by the following examples, which are set forth to illustrate the presently disclosed subject matter and are not to be construed as limiting.

### EXAMPLE 1

### Washcoat Adhesion

To evaluate adhesion, washcoats of varying compositions were applied to ceramic honeycomb substrates to form bulk samples. Test cores having a size of 1 inch by 2.9 inches (2.54 cm by 7.37 cm) were taken from the bulk samples at the center inlet and the peripheral inlet. The washcoat adhesion was evaluated using an air pressure test as follows.

An individual sample was placed on a weighing pedestal in an oven at 200° C. and weighed after stabilizing for 30 minutes. The sample was then removed and allowed to cool at room temperature for 20 minutes. The cooled sample was placed on a test stand with the channels of the core oriented horizontally. Air was passed through the channels of the core using an air knife sweeping back and forth across the face of the core with a minimum air pressure of 90 psi for 20 sweeps (a total of 40 passes across the face of the core). Thereafter, the care was returned to the oven, allowed to stabilize at 200° C. for 30 minutes, and weighed. Washcoat loss (WCL) was calculated as follows:

$$WCL = \frac{Initial Sample Weight ( g ) - Final Sample Weight ( g )}{Total Wash Coat Loading ( g / {in}^{3} ) \times Core Volume ( {in}^{3} )} \times 100$$

Comparative samples were formed of a 400 cell per square inch (CPSI) honeycomb substrate coated with a tungsta/titania catalytic material mixed with a binder. The sample ID of the coatings used in the respective comparative samples, as well as the binder used in each coating, is summarized in TABLE 1 below. In each case, the catalytic material was 10% by weight WO₃ with the balance titania. The titania in Comparative sample 1 was sourced from Precheza, a.s., and the titania in Comparative samples 2-8 was sourced from Cristal. In each case, the TiO₂ was prepared via the sulfate process and contained 10% by weight WO₃, as noted above. The binder was an alkaline silica sol (e.g., a LUDOX® sol available from W. R. Grace or silica sol available from Nissan Chemical) or an acidic silica sol (e.g., silica sol available from Nalco or silica sol available from Nissan Chemical). Comparative samples 1, 2, 3, 4, 5, and 8 had an initial washcoat loading of 3 g/in³, and Comparative samples 6 and 7 had an initial washcoat loading of 4 g/in³. The catalytic materials of the Comparative samples thus all had a nominal composition as follows: 83.57% anatase TiO₂, 9.29% WO₃, 2.5% V₂O₅, and 4.64% SiO₂, all percentages being by weight, based on the total weight of the catalytic material.

TABLE 1

| Comparative Sample ID | Binder |
|---|---|
| Comp. 1 | Alkaline silica sol |
| Comp. 2 | Alkaline silica sol |
| Comp. 3 | Acidic silica sol |
| Comp. 4 | Alkaline silica sol |
| Comp. 5 | Alkaline silica sol |
| Comp. 6 | Alkaline silica sol |
| Comp. 7 | Acidic silica sol |
| Comp. 8 | Alkaline silica sol |

Inventive samples were formed of a co-precipitate as described herein including 2.5% by weight V₂O₅, 10% by weight WO₃, and balance titania. Inventive sample 1 was the co-precipitate coated on a 400 CPSI honeycomb substrate with an initial washcoat loading of 3 g/in³. Inventive sample 2 was the co-precipitate coated on a 600 CPSI honeycomb substrate with an initial washcoat loading of 3 g/in³. The average WCL (average values from the center inlet cores and peripheral inlet cores) for the Comparative samples and the Inventive samples is shown in TABLE 2.

TABLE 2

| Sample ID | Avg. WCL |
|---|---|
| Comp. 1 | 5.82% |
| Comp. 2 | 8.47% |
| Comp. 3 | 5.59% |
| Comp. 4 | 10.38% |
| Como. 5 | 6.78% |
| Comp. 6 | 5.71% |
| Comp. 7 | 6.58% |
| Comp. 8 | 14.25% |
| Inventive 1 | 1.10% |
| Inventive 2 | 0.87% |

As seen above, whereas the comparative samples exhibited an average WCL in the range of 5.59% to 14.25%, the inventive samples exhibited average WCL values of 1.10% and 0.87%. This shows that washcoats formed with the present co-precipitate material have significantly improved adhesion which would be expected to provide for significant improvements in lifetime performance of the catalytic articles including the co-precipitate as a washcoat.

### EXAMPLE 2

### Powder Analysis

A co-precipitate material according to the present disclosure was prepared, and powder from the calcined material was analyzed fresh and after being aged in air for 4 hours at 600° C. Surface area, pore radius, total pore volume (TPV), and pore distribution values for the samples are provided below in TABLE 3.

TABLE 3

| | Sample | |
|---|---|---|
| | Co-Precipitate of Vanadia, Tungsta, | |
| | and Titania (2.5 wt % V₂O₅, | |
| | 10 wt % WO₃, balance TiO₂) | |
| Parameter | Fresh | Aged |
| BET Surface Area (m²/g) | 116.4 | 88.97 |
| Micropore BET (m²/g) | 2.06 | 2.14 |
| Average Pore Radius (Å) | 28.94 | 34.41 |
| Total Pore Volume (cm³/g) | 0.20465 | 0.18967 |
| Micro Pore Volume (cm³/g) | −0.00063 | −0.00019 |
| Pore Volume Between 10 | 0.20960 | 0.18649 |
| and 300 Å | | |

### EXAMPLE 3

### Washcoat Analysis

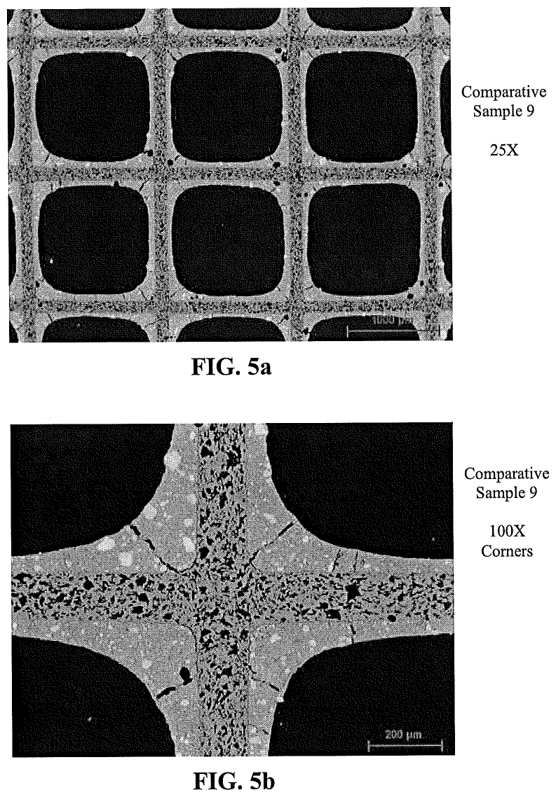

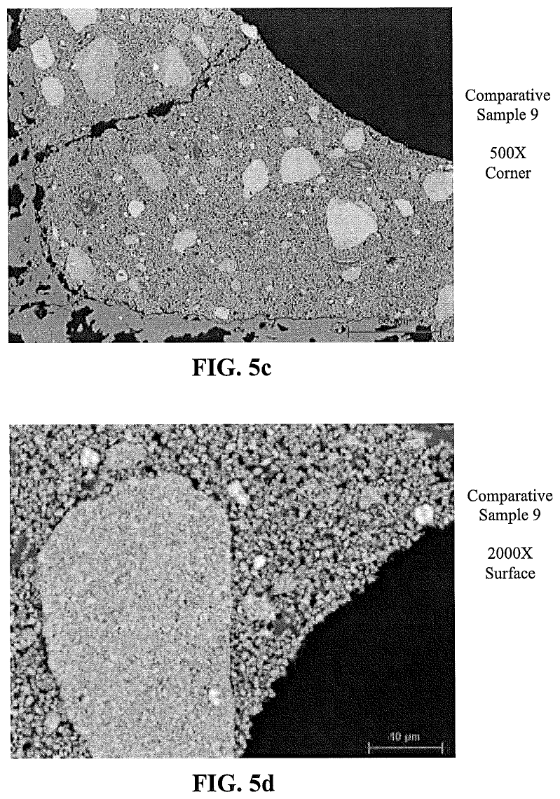

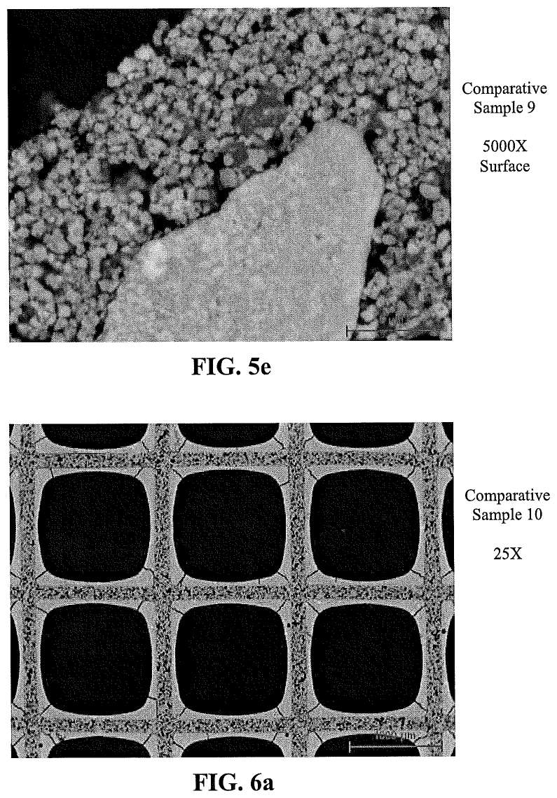

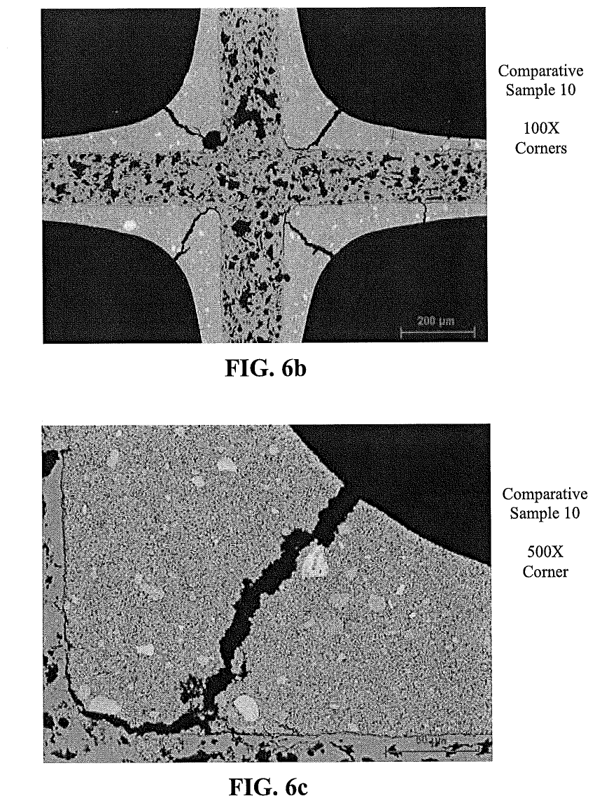

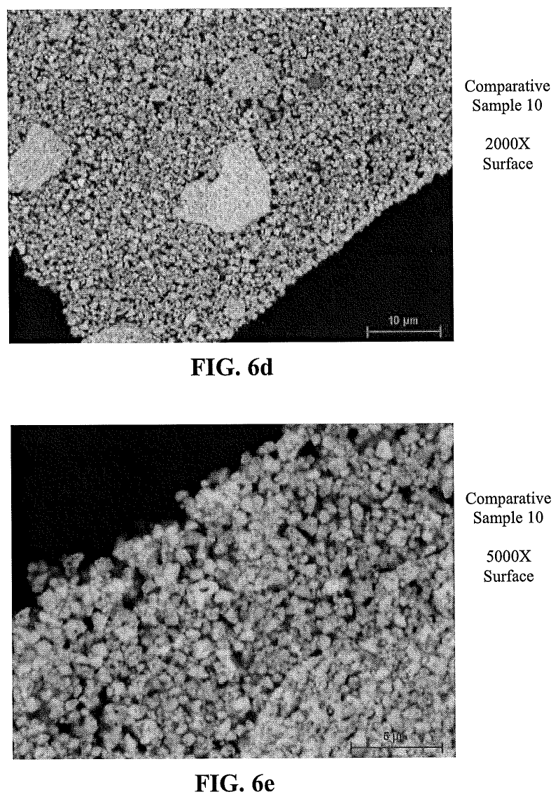

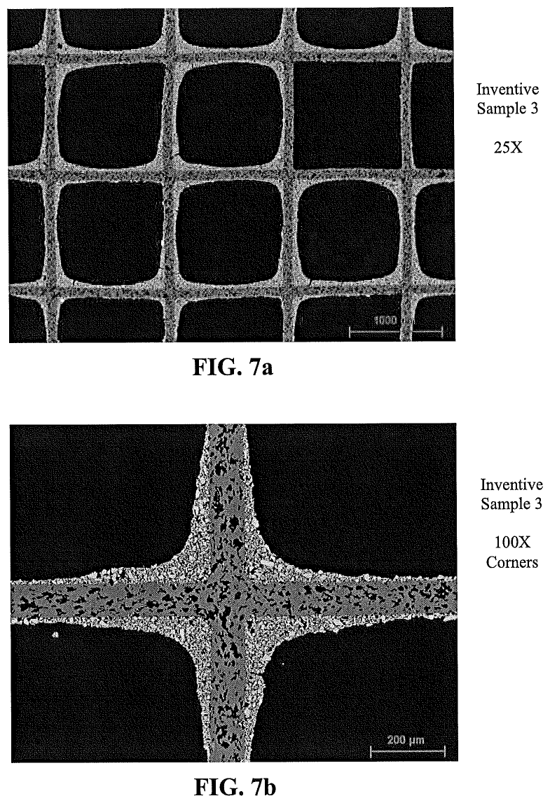

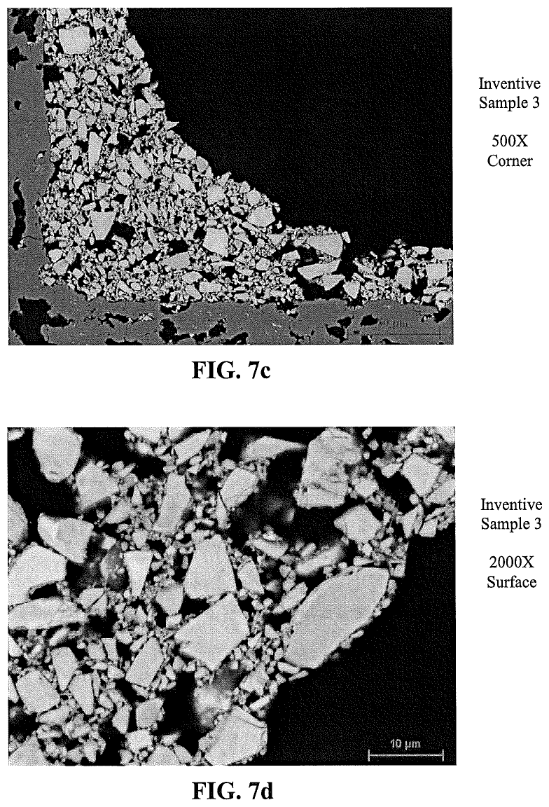

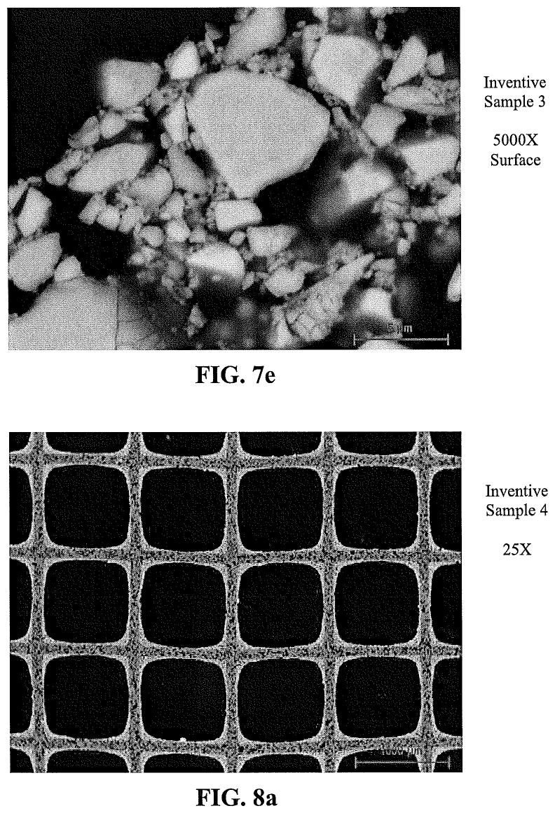

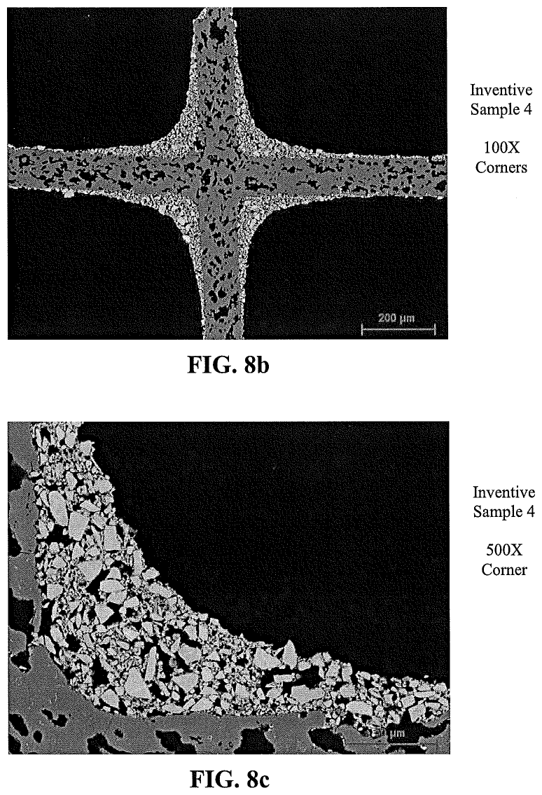

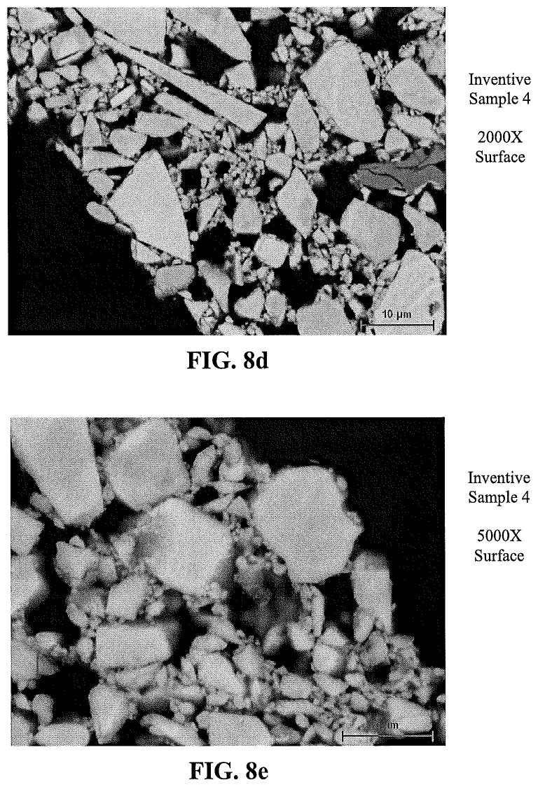

Catalytic articles were prepared by applying a washcoat of a catalytic material on a ceramic honeycomb substrate. Comparative sample 9 was formed with a washcoat of 2.5% by weight vanadia, 10% by weight WO₃, and balance titania. Comparative sample 10 was formed with a washcoat that included an alkaline silica sol binder and had a nominal composition as noted in Example 1. The comparative samples were coated on a 400 CPSI substrate. Inventive sample 3 was formed with a washcoat of a VTT co-precipitate as described herein on a 400 CPSI substrate, and Inventive sample 4 was formed with a washcoat of a VTT co-precipitate as described herein on a 400 CPSI substrate. No binder was used in the Inventive samples. The washcoats were applied, and the formed articles were calcined. Provided in FIG. 5a through FIG. 8c are SEM images of the respective samples showing distinct differences in the nature of the washcoats. The inventive washcoats exhibited significantly less cracking and greater porosity.

### EXAMPLE 4

### Catalytic Activity

To evaluate activity, a co-precipitate according to the present disclosure formed of 2.5% by weight V₂O₅, 10% by weight WO₃, and balance TiO₂ was applied as a washcoat to a ceramic honeycomb substrate and subjected to model testing as described below. Two comparative samples were also tested. Comparative sample 11 and Comparative sample 12 were each formed of a ceramic honeycomb with a washcoat having a nominal composition as noted in Example 1. Comparative sample 11 included one washcoat for a total loading of 3.0 g/in³. Comparative sample 12 included two washcoats for a total loading of 4.5 g/in³.

Samples of the above-described comparative and inventive materials were prepared with a length of 76.2 mm and a width of 18.1 mm Each sample was placed in a test reactor with a seal to prevent gas by-pass. Feed gas introduced to the reactor consisted of a carrier gas formed of 10% by volume O₂ (at a flow rate of 9.37 L/Min) and balance N₂ (at a flow rate of 9.32 L/Min) and a test gas formed of 500 ppm ammonia (at a flow rate of 0.52 L/Min) and 500 ppm NOx (at a flow rate of 0.52 L/Min). Total gas flow rate was 20.8 L/min.

The reactor was first raised in temperature to 250° C. and held for 20 minutes under the gas flow conditions noted above. After 20 minutes, outlet NO and NH₃ readings were taken. The NO flow was then stopped while the remaining gas was allowed to flow to reach a steady state. Thereafter, the NH₃ flow was stopped, and the NO flow was re-started. After a steady state was reached for the NO flow, the gases were continued for an additional 10 minutes. Thereafter, the NH₃ flow was re-started, and the temperature was ramped to 525° C. at which temperature the final gas outlet readings were obtained. Test results are shown in TABLE 4.

TABLE 4

| | NH₃ Storage at | NOx Reduction at | NH₃ Slip at |
|---|---|---|---|
| Test Sample | 250° C. (g/L) | 450° C. (%) | 450° C. (ppm) |
| Comp. 11 | 0.706 | 68.44 | 32.5 |
| Comp. 12 | 0.889 | 72.74 | 26.2 |
| Inventive 5 | 0.679 | 72.94 | 29.1 |

### EXAMPLE 5

### Pore Area

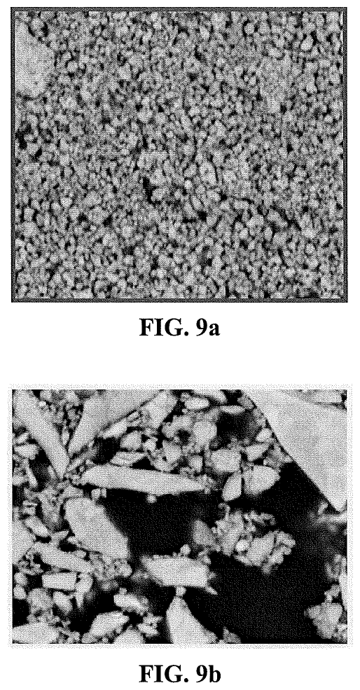

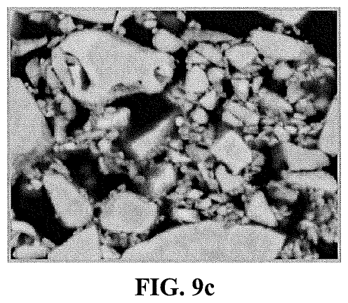

To evaluate pore area, a comparative washcoat was compared with two inventive washcoats. Comparative sample 13 was formed of a ceramic honeycomb with a washcoat having a nominal composition as noted in Example 1. Inventive sample 6 and Inventive sample 7 were each a washcoat formed of a co-precipitate according to the present disclosure formed of 2.5% by weight V₂O₅, 10% by weight WO₃, and balance TiO₂, with Inventive sample 6 being applied to a 400 CPSI honeycomb and Inventive sample 7 being applied to a 600 CPSI honeycomb. For each sample images were taken at 2,000× magnification using a scanning electron microscope, and the images were evaluated using a VHX-5000 digital microscope. The calculated areas are shown below in TABLE 5. The SEM images are shown in FIG. 9a (Comp. 13), FIG. 9b (Inventive 6) and FIG. 9c (Inventive 7).

TABLE 5

| Test Sample | Pore Area | Relative Increase |
|---|---|---|
| Comp. 13 | 0.70 μm² | Control |
| Inventive 6 | 4.57 μm² | 6.5x |
| Inventive 7 | 3.68 μm² | 5.2x |

Many modifications and other embodiments of the inventions set forth herein will come to mind to one skilled in the art to which these inventions pertain having the benefit of the teachings presented in the foregoing descriptions. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A catalytic article comprising a substrate that includes a catalytic material comprising calcined particles of a co-precipitate of vanadia, tungsta, and titania.

2. The catalytic article of claim 1, wherein the calcined particles of the co-precipitate are predominately crystalline.

3. The catalytic article of claim 1, wherein the calcined particles of the co-precipitate exhibit conchoidal fractures.

4. The catalytic article of claim 1, wherein the calcined particles of the co-precipitate comprise agglomerates of individual nanoparticles, the agglomerates having a particle size distribution of d10<20 μm, d50<100 μm, d90<210 μm, and the individual nanoparticles having an average size of about 5 nm to about 20 nm.

5. The catalytic article of claim 1, wherein the calcined particles of the co-precipitate comprise a coarse fraction having an average size of greater than 150 μm and a fine fraction having an average size of less than 150 μm.

6. The catalytic article of claim 1, wherein the calcined particles of the co-precipitate have a BET surface area of about 100 m²/g to about 180 m²/g.

7. The catalytic article of claim 1, wherein the calcined particles of the co-precipitate comprise about 0.1% to about 15% by weight vanadia, about 1% to about 20% by weight tungsta, and the balance titania, said weights based on the total weight of the calcined particles of the co-precipitate.

8. The catalytic article of claim 1, wherein about 50% or greater by weight of the titania in the calcined particles of the co-precipitate is in the anatase form.

9. The catalytic article of claim 8, wherein the titania has an average crystallite size of about 5 nm to about 15 nm.

10. The catalytic article of claim 1, wherein the article comprises the substrate and a coating on one or more surfaces of the substrate, the coating including the catalytic material comprising the calcined particles of the co-precipitate.

11. The catalytic article of claim 10, wherein the coating exhibits a washcoat adhesion average weight loss of less than 3%.

12. The catalytic article of claim 11, wherein the coating is substantially free of any binder.

13. The catalytic article of claim 10, wherein the coating has a porosity of about 5,000 Angstroms to about 10,000 Angstroms.

14. The catalytic article of claim 1, wherein the substrate is formed of the catalytic material.

15. The catalytic article of claim 14, wherein the catalytic material further comprises a content of non-calcined co-precipitate of vanadia, tungsta, and titania.

16. The catalytic article of claim 15, wherein the catalytic material is a homogeneous mixture of the calcined particles of the co-precipitate and the non-calcined co-precipitate.

17. A method of forming a catalytically active substrate, the method comprising: extruding a mixture of a catalytic material into a desired form; and
drying the extruded mixture to provide the catalytically active substrate;
wherein the mixture of a catalytic material comprises: calcined particles of a co-precipitate of vanadia, tungsta, and titania; and a content of non-calcined co-precipitate of vanadia, tungsta, and titania.

18. A method of improving adhesion of a catalytic coating of vanadia and titania on a substrate, the method comprising providing the coating as a material comprising calcined particles of a co-precipitate of vanadia, tungsta, and titania.
